(19) United States
(12) Patent Application Publication
(10) Pub. No.: US 2026/0298335 A1
(43) Pub. Date: Oct. 1, 2026

(54) SHIFT-BY-WIRE APPARATUS

(71) Applicant: Isuzu Motors Limited, Kanagawa (JP)

(72) Inventors: Pongsathon SRISUWAN, Samutprakan (TH); Rianpanya FA-AMNUYPOL, Samutprakan (TH)

(73) Assignee: Isuzu Motors Limited, Kanagawa (JP)

(21) Appl. No.: 19/577,499

(22) Filed: Mar. 25, 2026

(30) Foreign Application Priority Data
Mar. 26, 2025 (JP) 2025-052264

(51) Int. Cl. F16H 59/10

(52) U.S. Cl. CPC F16H 59/105

(57) ABSTRACT

A shift-by-wire apparatus of the present disclosure includes: a lever shaft that is operable in a predetermined direction; a plurality of detents that are provided sequentially in the predetermined direction; a contact portion that is provided on the lever shaft and that comes into contact with the plurality of detents; a magnet that is provided on the lever shaft; and a sensor board on which a sensor outputting a detection signal corresponding to a position of the magnet is provided, in which each of the plurality of detents includes an inclined surface, the inclined surface being inclined to push the lever shaft toward the sensor board when the lever shaft is operated in the predetermined direction while the contact portion is in contact with one of the plurality of detents.

### RELATED APPLICATION

This application claims the benefit of priority of Japanese Patent Application No. 2025-52264, filed on Mar. 26, 2025, the contents of which are all incorporated by reference herein in their entirety.

### TECHNICAL FIELD

The present disclosure relates to a shift-by-wire apparatus.

### BACKGROUND ART

In recent years, a shift-by-wire apparatus has generally been used in a transmission system of a vehicle. The shift-by-wire apparatus detects the position of a shift lever by a sensor and controls an operation state of a transmission based on a detection signal output from the sensor. Such a shift-by-wire apparatus is described in, for example, Patent Literature (hereinafter, referred to as PTL) 1 and the like.

### CITATION LIST

### Patent Literature

PTL 1

Japanese Patent Application Laid-Open No. 2007-198574

### SUMMARY OF INVENTION

### Technical Problem

Incidentally, in the shift-by-wire apparatus, the transmission may not be appropriately controlled when the position of the shift lever cannot be detected by the sensor or the detection accuracy is reduced. Therefore, it is required to correctly detect the position of the shift lever by the sensor.

The present disclosure has been made in consideration of the above point and provides a shift-by-wire apparatus that can improve reliability of detection of the shift lever position.

### Solution to Problem

On aspect of the present disclosure is a shift-by-wire apparatus that includes: a lever shaft that is operable in a predetermined direction; a plurality of detents that are provided sequentially in the predetermined direction; a contact portion that is provided on the lever shaft and that comes into contact with the plurality of detents; a magnet that is provided on the lever shaft; and a sensor board on which a sensor outputting a detection signal corresponding to a position of the magnet is provided, in which each of the plurality of detents includes an inclined surface, the inclined surface being inclined to push the lever shaft toward the sensor board when the lever shaft is operated in the predetermined direction while the contact portion is in contact with one of the plurality of detents.

### Advantageous Effects of Invention

According to the present disclosure, reliability of detection of the shift lever position can be improved.

### BRIEF DESCRIPTION OF THE SEVERAL VIEWS OF THE DRAWINGS

FIG. 1 is an exploded perspective view of a configuration of a shift lever according to an embodiment;

FIG. 2 is a diagram for describing a positional relationship between a magnet and a sensor;

FIG. 3 is a schematic diagram illustrating a shift position in the example of the embodiment;

FIG. 4A is a diagram illustrating the position of a pin when a lever shaft is set to the P position;

FIG. 4B is a diagram illustrating the position of the pin during transition of the lever shaft from the P position to the R position;

FIG. 4C is a diagram illustrating the position of the pin when the lever shaft is set to the R position;

FIG. 5 is an exploded perspective view for illustrating a relationship between the lever shaft and a sensor board;

FIG. 6 is a diagram illustrating a relationship between a digital output from the sensor and the shift position;

FIG. 7 is a block diagram illustrating a schematic configuration of a vehicle equipped with the shift-by-wire apparatus according to the embodiment; and

FIG. 8 is a schematic side view of an inclined surface formed on a detent according to the embodiment, and a schematic side view for describing the operation according to the embodiment.

### DESCRIPTION OF EMBODIMENTS

Hereinafter, the embodiment of the present invention will be described with reference to the drawings.

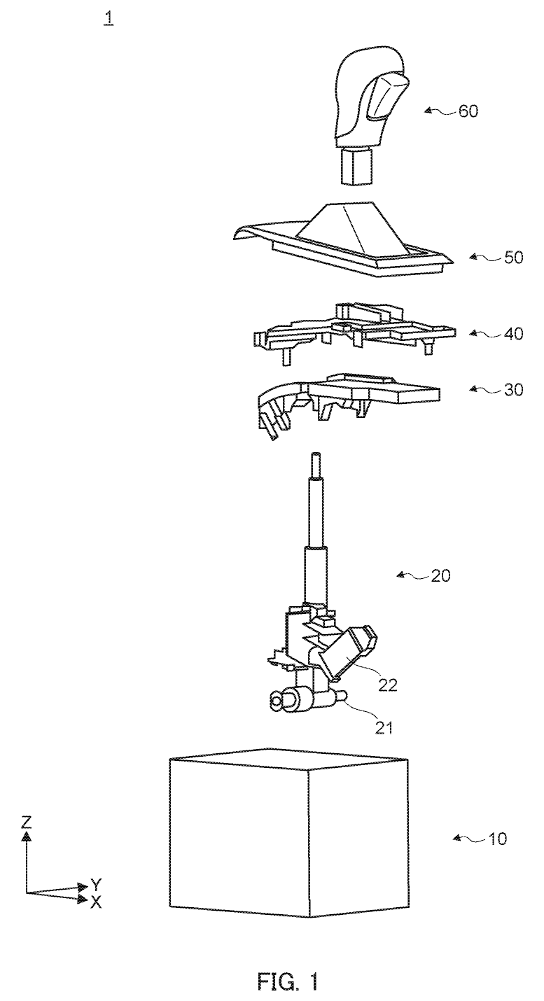

FIG. 1 is an exploded perspective view of a configuration of shift lever 1 according to the embodiment. Shift lever 1 includes shift lever body 10, lever shaft 20, guide cover 30, upper cover 40, shift boot 50, and shift knob 60.

Shift lever body 10 is fixed to a vehicle body beside the driver’s seat. Lever shaft 20 includes rotation shaft 21 on the lower side. Rotation shaft 21 is rotatably attached to shift lever body 10.

Guide cover 30 is attached to an opening portion of shift lever body 10 at the upper portion. An opening portion through which a shaft portion of lever shaft 20 penetrates is formed in a central portion of guide cover 30. Thus, the lower base portion of lever shaft 20 is stored in shift lever body 10, and the shaft portion on the upper side protrudes upward from guide cover 30.

Shift knob 60 is connected to the tip of lever shaft 20 on the upper side. Thus, when shift knob 60 is operated by the driver, lever shaft 20 rotates about rotation shaft 21 in response to the operation.

Shift boot 50 and upper cover 40 are fixed to the vehicle body and have a structure that covers guide cover 30 without interfering with the movement of shift knob 60 and lever shaft 20 during shift operation.

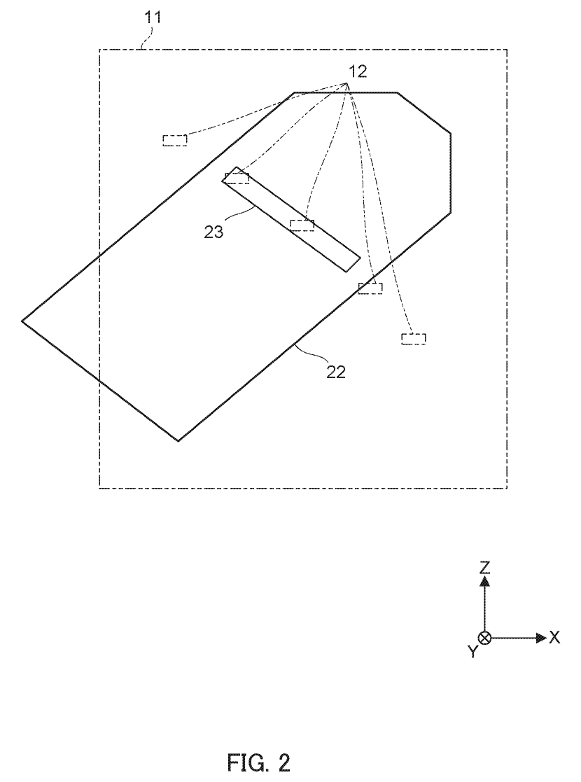

Magnet mounting portion 22 is provided on lever shaft 20. Magnet mounting portion 22 is provided at a position above rotation shaft 21 and below a shaft body of lever shaft 20. As illustrated in FIG. 2, magnet 23 for detecting a rotation position of lever shaft 20 is fixedly provided on magnet mounting portion 22.

In addition, as shown by a chain line in FIG. 2, sensor board 11 is provided at a position in shift lever body 10 facing magnet mounting portion 22. Sensor 12 constituted by Hall ICs is provided on sensor board 11. In the present embodiment, sensor 12 is a digital sensor, and outputs a voltage corresponding to a relative position to magnet 23 by four Hall ICs. As a result, sensor 12 outputs a detection signal corresponding to the rotation position of lever shaft 20. The number of Hall ICs of sensor 12 is not limited to the example in FIG. 2.

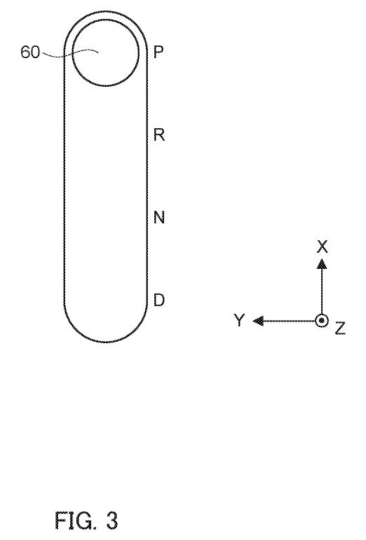

FIG. 3 illustrates a shift position in the example of the present embodiment. Shift lever 1 is set to any of a P (parking position), an R (reverse position), an N (neutral position), or a D (drive position) in response to the operation of shift knob 60 by the driver.

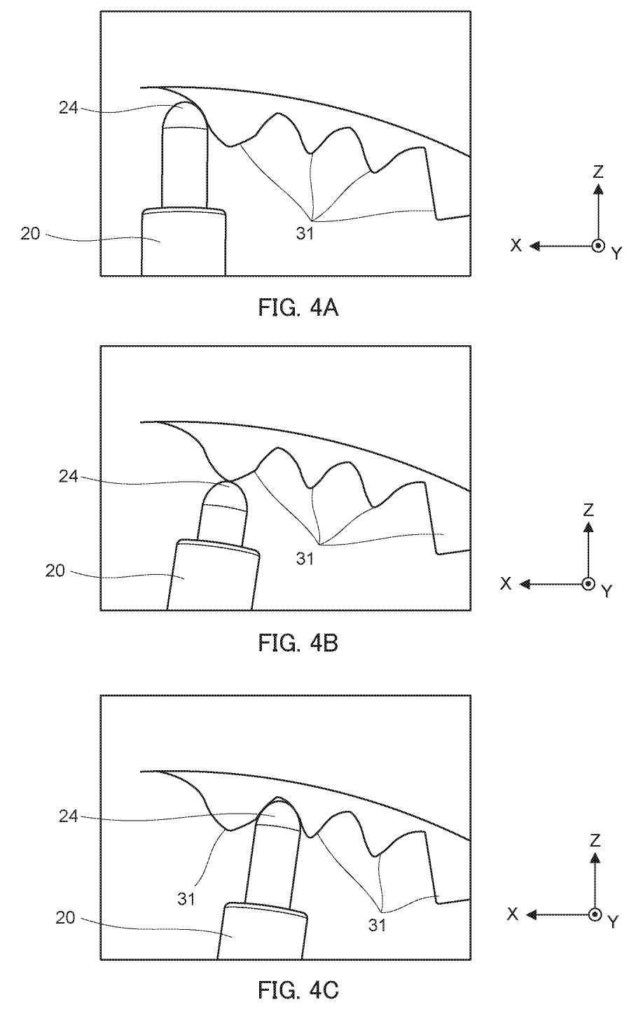

A plurality of detents 31 as illustrated in FIGS. 4A-4C are formed on the lower surface of guide cover 30. Meanwhile, pin 24 as a contact portion is provided on the side surface of lever shaft 20 facing detents 31. Pin 24 is pressed against detents 31 by a spring force. Pin 24 transitions to any position of detents 31 in response to the rotation of lever shaft 20 by the driver.

FIG. 4A illustrates the position of pin 24 when lever shaft 20 is set to the P position. FIG. 4B illustrates a position of pin 24 during transition of lever shaft 20 from the P position to the R position. FIG. 4C illustrates a position of pin 24 when lever shaft 20 is set to the R position.

The P, R, N, and D positions are determined depending on which recessed portion of detent 31 pin 24 is fitted into. The shift change is performed by the driver applying, to lever shaft 20, a rotation force equal to or greater than a certain force such that pin 24 passes over detent 31.

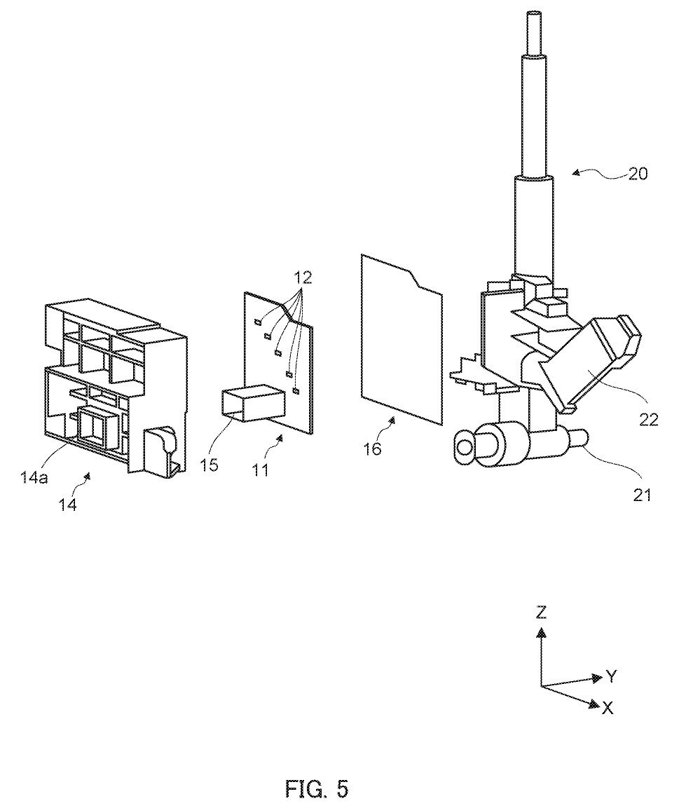

FIG. 5 is an exploded perspective view for describing a relationship between lever shaft 20 and sensor board 11.

Sensor board 11 is fixed to base 14 by, for example, a screw. Base 14 is fixed inside shift lever body 10 by, for example, a screw. Accordingly, sensor 12 of sensor board 11 is disposed to face magnet 23 (see FIG. 2) of magnet mounting portion 22.

In addition, sensor board 11 includes connector 15. Connector 15 is fitted into through-hole 14a of base 14. A wiring harness of the vehicle is connected to connector 15. This allows the power supply for sensor 12 to be supplied to sensor 12 through the wiring harness, and the output of sensor 12 to be output to an electronic control unit (ECU) of the vehicle through the wiring harness.

In addition, for example, seal 16 made of a material having excellent strength, non-magnetic properties, and electrical insulation, such as polycarbonate, is adhered to a surface of sensor board 11 facing magnet mounting portion 22.

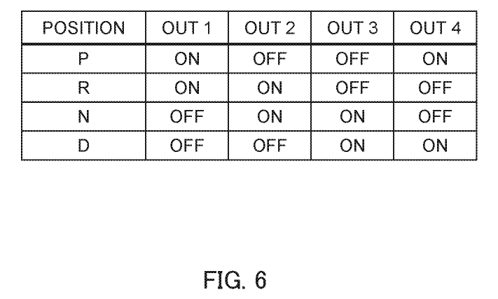

FIG. 6 is a diagram illustrating a relationship between the digital output from sensor 12 and the shift position. In FIG. 6, the terms “OUT1,” “OUT2,” “OUT3,” and “OUT4” indicate digital signals respectively output from sensors 12.

Note that, although the number of sensors 12 is five, the number of outputs is four because, in the example of the present embodiment, the outputs of two of the digital sensors are combined into a single output for one digital sensor pair. For example, the outputs of two sensors 12 on the right side in FIG. 2 are combined and output as “OUT4.”

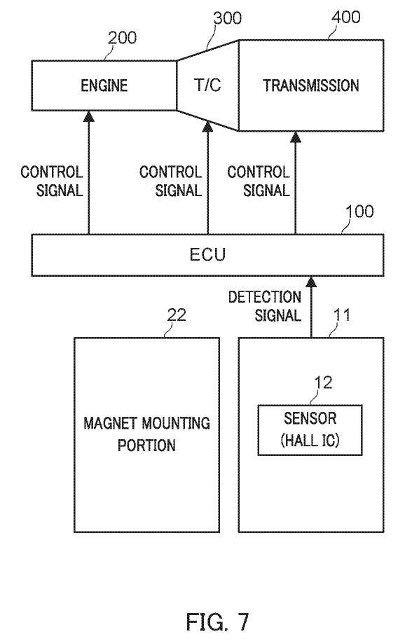

FIG. 7 is a block diagram illustrating a schematic configuration of a vehicle equipped with the shift-by-wire apparatus according to the present embodiment.

The shift-by-wire apparatus includes magnet mounting portion 22, sensor board 11, and ECU 100 as a controller. As described above, magnet mounting portion 22 includes magnet 23. Sensor board 11 includes sensor 12. ECU 100 controls engine 200, torque converter (T/C) 300, and transmission 400. Transmission 400 is controlled to any of the P, R, N, or D operation states by ECU 100.

The detection signal output from sensor 12 is transmitted to ECU 100, and ECU 100 controls the operation state of transmission 400 based on the detection signal.

Specifically, ECU 100 stores the relationship between the output (detection signal) of sensor 12 illustrated in FIG. 6 and the shift position as a table. ECU 100 determines which shift position the input detection signal corresponds to by referring to the table. Then, ECU 100 controls transmission 400 such that the operation state of transmission 400 corresponds to the shift position obtained as a result of the determination.

ECU 100 includes a processor constituted by a central processing unit (CPU), read only memory (ROM), random access memory (RAM), and the like as main components. ECU 100 executes a predetermined program to output a control signal for controlling engine 200, torque converter (T/C) 300, and transmission 400. All or a part of ECU 100 may be formed of a hard-wired circuit such as an application specific integrated circuit (ASIC) or a field-programmable gate array (FPGA).

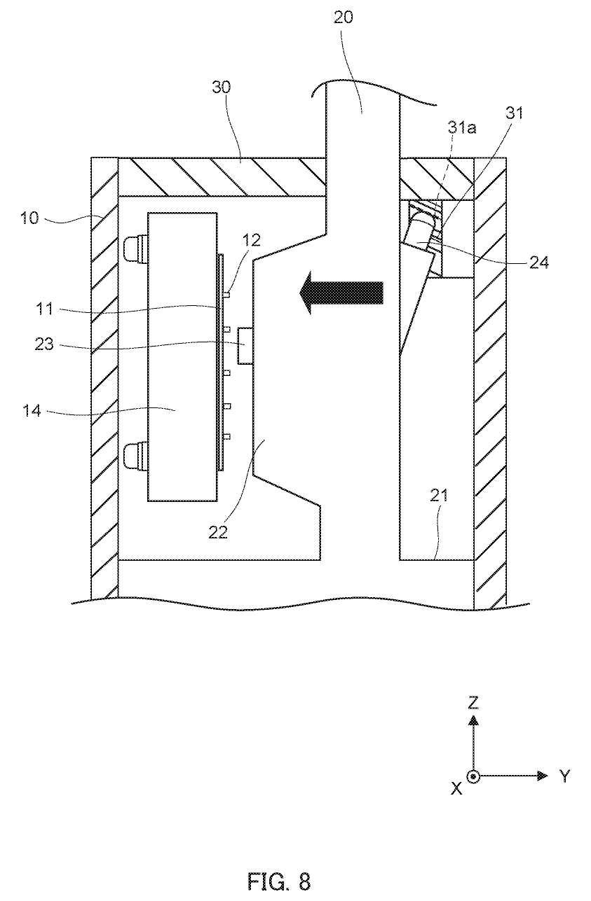

FIG. 8 is a schematic side view of inclined surface 31a formed on detent 31 according to the embodiment, and a schematic side view for describing the operation according to the embodiment. Note that FIG. 8 shows a positional relationship between lever shaft 20 and sensor board 11 inside shift lever body 10, with part of shift lever body 10 and guide cover 30 cut away along the YZ plane.

In the present embodiment, detent 31 includes inclined surface 31a that is inclined such that lever shaft 20 is pushed in a direction of sensor board 11 (direction indicated by arrow in the drawing) when lever shaft 20 rotates while pin 24 as a contact portion is in contact with detent 31 (when lever shaft 20 rotates around the Y axis in the drawing with rotation shaft 21 as rotation center).

This suppresses a decrease in sensing sensitivity caused by an increase in the distance between magnet 23 and sensor 12 of sensor board 11.

Here, a force from the user is applied to lever shaft 20 each time the shift operation is performed by the user. In addition, the shift operation is frequently performed. Therefore, due to aging deterioration, there is a possibility that looseness may occur in the attachment portion of rotation shaft 21 to shift lever body 10. When this looseness causes the distance between magnet 23 and sensor 12 of sensor board 11 to become greater than the specified distance, the sensing sensitivity of sensor 12 decreases.

In the present embodiment, by forming, on detent 31, inclined surface 31a that pushes lever shaft 20 in the direction of sensor board 11 during rotation, even when looseness occurs in the attachment portion of rotation shaft 21 to shift lever body 10, the distance between magnet 23 and sensor 12 of sensor board 11 can be kept within the specified distance, and a decrease in sensing sensitivity can be avoided.

As described above, according to the present embodiment, the following form is adopted.

(1) One aspect of the shift-by-wire apparatus according to the present embodiment includes: lever shaft 20 that is operable in a predetermined direction; a plurality of detents 31 that are provided sequentially in the predetermined direction; a contact portion (pin 24) that is provided on lever shaft 20 and that comes into contact with the plurality of detents 31; magnet 23 that is provided on lever shaft 20; and sensor board 11 on which sensor 12 outputting a detection signal corresponding to a position of magnet 23 is provided, in which each of the plurality of detents 31 includes inclined surface 31a inclined to push lever shaft 20 toward sensor board 11 when lever shaft 20 is operated in the predetermined direction while the contact portion (pin 24) is in contact with one of the plurality of detents 31.

As a result, reliability of the position detection of the shift lever can be improved.

(2) In one aspect of the shift-by-wire apparatus according to the present embodiment, in the above (1), lever shaft 20 is rotatably connected to shift lever body 10 in the predetermined direction, and sensor board 11 is fixed to shift lever body 10 such that a surface on which sensor 12 is mounted is substantially orthogonal to rotation shaft 21 of lever shaft 20.

The above-described embodiment merely describes an example of specific implementation for practicing the present disclosure, and should not be construed as limiting the technical scope of the present disclosure. That is, the present disclosure can be carried out in various forms without departing from the spirit and the main features thereof.

In the above-described embodiment, the case where sensor 12 is a digital sensor has been described, but sensor 12 may be an analog sensor.

In the above-described embodiment, the case has been described in which the shift-by-wire apparatus according to the present disclosure is applied to the vehicle including engine 200, but the present invention is not limited thereto. The shift-by-wire apparatus according to the present disclosure can also be applied to, for example, an electric vehicle including a transmission.

### INDUSTRIAL APPLICABILITY

The shift-by-wire apparatus according to the present disclosure can be widely applied when controlling a transmission according to the position of a shift lever.

### REFERENCE SIGNS LIST

1 Shift lever

10 Shift lever body

11 Sensor board

12 Sensor

14 Base

15 Connector

16 Seal

20 Lever shaft

21 Rotation shaft

22 Magnet mounting portion

23 Magnet

24 Pin

30 Guide cover

31 Detent

31a Inclined surface

40 Upper cover

50 Shift boot

60 Shift knob

100 ECU

400 Transmission

What is claimed is:

1. A shift-by-wire apparatus, comprising:
a lever shaft that is operable in a predetermined direction;
a plurality of detents that are provided sequentially in the predetermined direction;
a contact portion that is provided on the lever shaft and that comes into contact with the plurality of detents;
a magnet that is provided on the lever shaft; and
a sensor board on which a sensor outputting a detection signal corresponding to a position of the magnet is provided, wherein
each of the plurality of detents includes an inclined surface, the inclined surface being inclined to push the lever shaft toward the sensor board when the lever shaft is operated in the predetermined direction while the contact portion is in contact with one of the plurality of detents.

2. The shift-by-wire apparatus according to claim 1, wherein
the lever shaft is rotatably connected to a shift lever body in the predetermined direction, and
the sensor board is fixed to the shift lever body such that a surface on which the sensor is mounted is substantially orthogonal to a rotation shaft of the lever shaft.
